(19) United States
(12) Patent Application Publication
(10) Pub. No.: US 2020/0380902 A1
(43) Pub. Date: Dec. 3, 2020

(54) DISPLAY DRIVING APPARATUS, DISPLAY DRIVING COMPONENT, AND DISPLAY DEVICE

(71) Applicants: BOE Technology Group Co., Ltd., Beijing (CN); HEFEI BOE OPTOELECTRONICS TECHNOLOGY CO., LTD., Anhui (CN)

(72) Inventor: Ping Chen, Beijing (CN)

(21) Appl. No.: 16/072,227

(22) PCT Filed: Dec. 13, 2017
(86) PCT No.: PCT/CN2017/115896

§ 371 Date: Jul. 24, 2018

(30) Foreign Application Priority Data
Apr. 21, 2017 (CN) 201710268846.7

(51) Int. Cl. G09G 3/20

(52) U.S. Cl. CPC G09G 3/20; G09G 2370/14; G09G 2310/0202; G09G 2310/0243; G09G 2310/08

(57) ABSTRACT

The embodiments of the present disclosure disclose a display driving apparatus, a display driving component, and a display device. The display driving apparatus comprises a display controller configured to generate a plurality of output signals, wherein the display controller has a plurality of output ports for outputting the generated plurality of output signals respectively; display drivers configured to generate a display signal according to at least a part of the plurality of output signals output by the output ports; and termination impedance matching networks connected between the display controller and the display drivers via a plurality of signal lines.

### TECHNICAL FIELD

Embodiments of the present disclosure relate to the field of display, and more particularly, to a display driving apparatus, a display driving component, and a display device.

### BACKGROUND

In a display driving apparatus, a Low Voltage Differential Signal (LVDS for short) generated by a signal source such as a graphics card etc. is transmitted to a timing control Integrated Circuit (IC) in the display driving apparatus. The timing control IC converts the received signal into a display data signal and a display control signal and transmits the signals to a display driving IC to control a display operation of a display panel. As the transmitted signals are high-frequency signals, the signals transmitted from the timing control IC to the display driving IC may be reflected on a transmission line, which causes signal oscillation on the transmission line.

### SUMMARY

According to an aspect of the embodiments of the present disclosure, there is proposed a display driving apparatus, comprising:

a display controller configured to generate a plurality of output signals, wherein the display controller has a plurality of output ports for outputting the generated plurality of output signals respectively;

display drivers configured to generate a display signal according to at least a part of the plurality of output signals output by the output ports; and

termination impedance matching networks connected between the display controller and the display drivers via a plurality of signal lines.

According to an embodiment of the present disclosure, for each of the display drivers, the display controller is connected to the display driver via at least one pair of signal lines of the plurality of signal lines, and the termination impedance matching networks each comprise impedance matching sub-networks connected between two signal lines of each pair of signal lines.

According to an embodiment of the present disclosure, the impedance matching sub-networks have the same impedance value.

According to an embodiment of the present disclosure, the impedance matching sub-networks each have an impedance value in a range of about 80 ohms to 85 ohms.

According to an embodiment of the present disclosure, the impedance matching sub-networks each comprise at least one resistor.

According to an embodiment of the present disclosure, the display controller and the display drivers are arranged in a substantial T-shaped layout.

According to an embodiment of the present disclosure, the termination impedance matching networks are as close as possible to the corresponding display drivers.

According to an embodiment of the present disclosure, the display controller comprises a timing control Integrated Circuit (IC) configured to receive an external signal and convert the received external signal into the plurality of output signals.

According to an embodiment of the present disclosure, the plurality of output signals are high-frequency signals transmitted in a form of Low Voltage Differential Signal (LVDS).

According to another aspect of the embodiments of the present disclosure, there is proposed a display driving component, comprising:

a printed circuit board;

a display controller configured to generate a plurality of signals, wherein the display controller has a plurality of output ports for outputting the generated plurality of signals respectively; and

display drivers configured to generate a display signal according to at least a part of the plurality of signals output by the output ports;

wherein the printed circuit board has termination impedance matching networks provided thereon, which are connected between the display controller and the display drivers via a plurality of signal lines on the printed circuit board.

According to an embodiment of the present disclosure, the display controller is located on a central line of the printed circuit board.

According to an embodiment of the present disclosure, the display controller is located at a center of the printed circuit board.

According to an embodiment of the present disclosure, the display controller and the display drivers are arranged in a substantial T-shaped layout.

According to an embodiment of the present disclosure, the termination impedance matching networks are as close as possible to the corresponding display drivers.

According to an embodiment of the present disclosure, the display controller comprises a timing control Integrated Circuit (IC) configured to receive an external signal and convert the received external signal into the plurality of output signals.

According to an embodiment of the present disclosure, the plurality of output signals are high-frequency signals transmitted in a form of Low Voltage Differential Signal (LVDS).

According to an embodiment of the present disclosure, for each of the display drivers, the display controller is connected to the display driver via at least one pair of signal lines of the plurality of signal lines, and the termination impedance matching networks each comprise impedance matching sub-networks connected between two signal lines of each pair of signal lines.

According to an embodiment of the present disclosure, the impedance matching sub-networks have the same impedance value.

According to an embodiment of the present disclosure, the impedance matching sub-networks each have an impedance value in a range of about 80 ohms to 85 ohms.

According to an embodiment of the present disclosure, the impedance matching sub-networks each is at least one resistor.

According to yet another aspect of the embodiments of the present disclosure, there is proposed a display device comprising the display driving apparatus according to the embodiments of the present disclosure.

According to a further aspect of the embodiments of the present disclosure, there is proposed a display device comprising the display driving component according to the embodiments of the present disclosure.

### BRIEF DESCRIPTION OF THE ACCOMPANYING DRAWINGS

In order to more clearly describe the technical solutions according to the embodiments of the present disclosure or in the conventional technologies, the accompanying drawings needed to be used in the description of the embodiments will be briefly described below. Obviously, the accompanying drawings in the following description are only some embodiments of the present disclosure. For those of ordinary skill in the art, other accompanying drawings can also be obtained based on these accompanying drawings without any creative work. In the accompanying drawings,

FIG. 1 illustrates a schematic block diagram of a display driving apparatus according to an exemplary embodiment of the present disclosure;

FIG. 2 illustrates a schematic diagram of a terminal impedance matching network according to an exemplary embodiment of the present disclosure;

FIG. 3 illustrates a schematic block diagram of a display driving apparatus according to another exemplary embodiment of the present disclosure;

FIG. 4 illustrates a schematic block diagram of a display driving component according to an exemplary embodiment of the present disclosure; and

FIG. 5 illustrates a schematic block diagram of a display driving component according to another exemplary embodiment of the present disclosure.

### DETAILED DESCRIPTION

In order to make the purposes, technical solutions and advantages of the embodiments of the present disclosure more clear, the technical solutions in the embodiments of the present disclosure will be clearly and completely described below in conjunction with the accompanying drawings in the embodiments of the present disclosure. Obviously, the embodiments described are a part of the embodiments of the present disclosure instead of all the embodiments. All other embodiments obtained by those of ordinary skill in the art based on the described embodiments of the present disclosure without contributing any creative work are within the protection scope of the present disclosure. It should be noted that throughout the accompanying drawings, the same elements are represented by the same or similar reference signs. In the following description, some specific embodiments are for illustrative purposes only and are not to be construed as limiting the present disclosure, but merely examples of the embodiments of the present disclosure. The conventional structure or construction will be omitted when it may cause confusion with the understanding of the present disclosure. It should be noted that shapes and dimensions of components in the figures do not reflect true sizes and proportions, but only illustrate contents of the embodiments of the present disclosure.

Unless otherwise defined, technical terms or scientific terms used in the embodiments of the present disclosure should be of ordinary meanings to those skilled in the art. “First”, “second” and similar words used in the embodiments of the present disclosure do not represent any order, quantity or importance, but are merely used to distinguish between different constituent parts.

There are usually two reasons for signal reflection during communication: impedance discontinuity and impedance mismatch. The impedance discontinuity means that a signal suddenly encounters a small impedance of a transmission line or even no impedance at the end of the transmission line, and thus a reflected signal is generated at this end. One of ways to eliminate this reflection is to bridge a termination resistor with the same impedance as a characteristic impedance of the transmission line at the end of the transmission line so that the impedance of the transmission line is continuous. As the transmission of the signal on the transmission line is bidirectional, a termination resistor with the same impedance may be connected at the other end of the transmission line. The impedance mismatch refers to impedance mismatch between a data transceiver and a transmission line. Reflection caused by this reason mainly occurs when a communication line is in an idle mode, which results in a disordered data transmission of the entire network. In order to reduce the effect of a reflected signal on the communication line, methods such as noise suppression and addition of bias resistors are often used.

An LVDS device is a high speed and low power consumption circuit design. An LVDS has characteristics such as a current driving mode and a low voltage swing, which may provide a higher signal transmission rate, and a differential transmission mode may be used to reduce both signal noises and Electromagnetic Interference (EMI). In the field of display, an LVDS signal is generated by a constant current source at a system end, for example, the constant current source may be a 3.5 mA current source. Then, current is transmitted to, for example, a timing control Integrated Circuit (IC) in a display driving apparatus via one path (for example, a positive pole) of differential signal lines. As the timing control IC exhibits a high resistance to direct current, the current results in a voltage of 350 mV. At the same time, the current flows back to the current source via the other path (for example, a negative pole) of the differential signal lines. After receiving, for example, the LVDS/an external signal from a Display Port (DP), the timing control IC performs signal conversion to provide an output signal of the timing control IC. The output signal of the timing control IC may comprise a data signal for driving a display panel and various control signals. In this conversion process, for example, a data transmission rate of the LVDS signal may be as high as 655 Mbps, and a data transmission rate of the output signal may be as high as 1.923 Gbps. The timing control IC transmits data to a source driving IC in a form of LVDS. In a case of such high-frequency data transmission, a wavelength of the signal is relatively short compared to the transmission line, and therefore a reflected wave may be formed by the signal at the end of the transmission line, thereby interfering with the original signal. In addition, as the frequency of the output signal of the timing control IC increases, some source driving ICs may have an insufficient driving capacity when a loading capability reaches a critical value, which results in poor display conditions and occurrence of snowflake points or line defects.

According to an embodiment of the present disclosure, reflection of a signal arriving at the end of a transmission line can be alleviated by adding terminal impedance matching networks. By adding the termination impedance matching networks, impedance matching between a signal source and the transmission line can be realized to reduce reflection and avoid oscillation, while reducing noises and radiation and preventing overshoot.

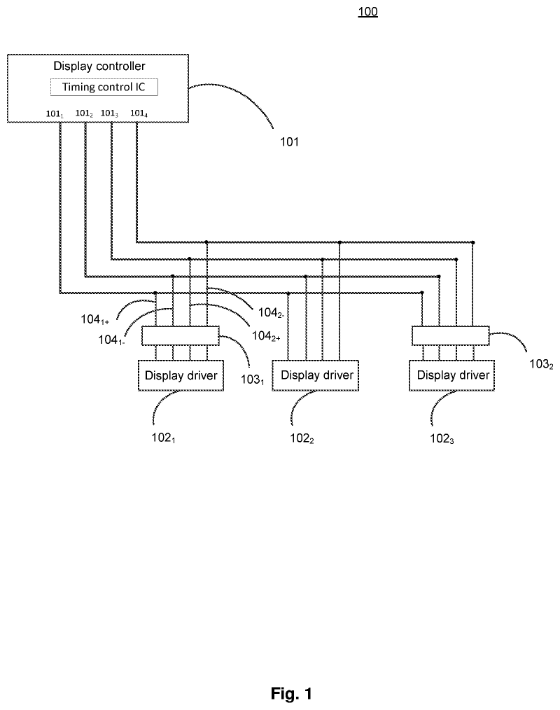

FIG. 1 illustrates a schematic diagram of a display driving apparatus according to an exemplary embodiment of the present disclosure. As shown in FIG. 1, the display driving apparatus 100 according to the exemplary embodiment of the present disclosure may comprise a display controller 101 configured to generate a plurality of output signals, wherein the display controller 101 has a plurality of output ports 101₁-101₄ for outputting the generated plurality of output signals respectively; display drivers 102₁-102₃ configured to generate a display signal according to at least a part of the plurality of output signals output by the output ports 101₁-101₄; and terminal impedance matching networks 103₁-103₂ connected between the display controller 101 and the display drivers via a plurality of signal lines 104₁₊, 104₁₋, 104₂₊ and 104₂₋. For ease of demonstration, FIG. 1 is described by taking three display drivers and two terminal impedance matching networks as an example. It can be understood by those skilled in the art that the display driving apparatus according to the embodiment of the present disclosure may comprise other numbers of display drivers and termination impedance matching networks.

For example, in the example of FIG. 1, the display controller 101 may comprise a timing control IC, and the signals output by the display controller 101 to the display drivers 102₁-102₃ may comprise four-parallel Mini-LVDS signals. For example, the display drivers 102₁-102₃ may be source driving ICs. The source driving ICs each receive and store a high-frequency LVDS signal from the display driver, and convert, depending on turn-on of a gate driving scan line, the LVDS signal into a voltage to be output to a pixel electrode to drive a display panel to display a desired image. For example, the four signal lines may comprise two pairs of signal lines (104₁₊, 104₁₋) and (104₂₊, 104₂₋), and image data to be displayed is transmitted in a form of a positive data signal and a negative data signal, respectively. It can be understood by those skilled in the art that the signals output by the display controller 101 to the display drivers 102₁-102₃ may further comprise a horizontal data start signal STH, a horizontal clock signal CPH, etc. Of course, the display controller 101 may further output a control signal such as a vertical data start signal STV, a vertical clock signal CPV, etc. required for display by the display panel to, for example, a gate driving IC. According to the embodiment shown in FIG. 1, the display controller 101 and the display drivers 102₁-102₃ are arranged in an “L-shaped” layout. In FIG. 1, there is no termination impedance matching network provided for the display driver 102₂. With this technical solution, the space can be saved and the design of the terminal impedance matching networks can be simplified.

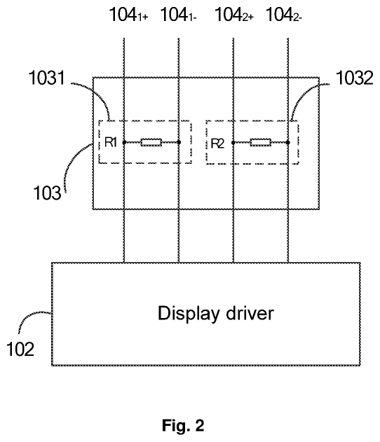

FIG. 2 illustrates a schematic diagram of the termination impedance matching network 103 of FIG. 1. The termination impedance matching networks 103₁ and 103₂ in FIG. 1 may have the same structure. As shown in FIG. 2, a signal line 104 may comprise a first pair of signal lines (104₁₊, 104₁₋) and a second pair of signal lines (104₂₊, 104₂₋). According to the embodiment of the present disclosure, the termination impedance matching network 103 may comprise impedance matching sub-networks 1031 and 1032 connected between two signal lines in each pair of signal lines. The impedance matching sub-networks 1031 and 1032 may comprise, for example, a resistor R1 connected between the signal line 104₁₊ and the signal line 104₁₋ and a resistor R2 connected between the signal line 104₂₊ and the signal line 104₂₋ in FIG. 2 respectively.

According to the embodiment of the present disclosure, the impedance matching sub-networks 1031 and 1032 may have the same impedance value as each other. According to a resistance calculation formula, a resistance value of a conductor is R=ρl/S, where p is a resistivity of a resistive material, l is a length of the resistive material, and S is a cross-sectional area of the resistive material. Therefore, in a case of a constant length, the smaller the cross-sectional area, the greater the resistance value. As a result, if the resistance value R becomes large, in a case of a constant resistivity and a constant length, it needs to adjust S. As the smaller the S, the greater the R, if S is too small, it may put forward a test to a manufacturing capability of a Printed Circuit Board (PCB). In consideration of the manufacturing capability of the PCB, in the case shown in FIG. 2, resistance values of the resistors R1 and R2 may be in a range of about 80 ohms to 100 ohms, for example, in a range of about 80 ohms to 85 ohms, or, for example, may be 82 ohms. In addition, it can be understood by those skilled in the art that although the resistor R1 and the resistor R2 are illustrated in a form of single resistors in FIG. 2, the resistor R1 and the resistor R2 may be implemented as a parallel resistor network or may be implemented in another form, as long as the required impedance value can be achieved. At the same time, the form of the parallel resistor network can provide system stability, while minimizing the impact on the system performance as much as possible even if a single resistor fails.

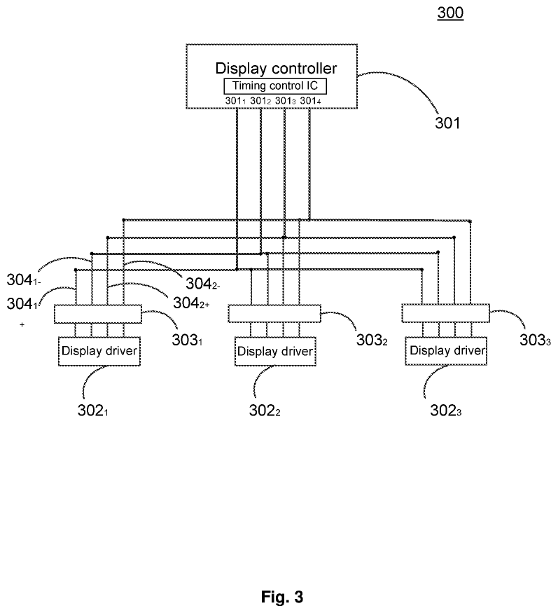

FIG. 3 illustrates a schematic block diagram of a display driving apparatus according to another exemplary embodiment of the present disclosure. Unlike the embodiment shown in FIG. 1, the embodiment shown in FIG. 3 provides a terminal impedance arrangement with a substantial “T-shaped” layout, and a termination impedance matching network is added at an intersection between a horizontal line and a vertical line of a “T-shape” in the substantial “T-shaped” network.

As shown in FIG. 3, the display driving apparatus 300 according to the other exemplary embodiment of the present disclosure may comprise a display controller 301 configured to generate a plurality of output signals, wherein the display controller 301 has a plurality of output ports 301₁-301₄ for outputting the generated plurality of output signals respectively; display drivers 302₁-302₃ configured to generate a display signal according to at least a part of the plurality of output signals output by the output ports 301₁-301₄; and terminal impedance matching networks 303₁-303₃ connected between the display controller 301 and the display drivers 302₁-302₃ via a plurality of signal lines 304₁₊, 304₁₋, 304₂₊ and 304₂₋. In FIG. 3 is described by taking three display drivers and three terminal impedance matching networks as an example. It can be understood by those skilled in the art that the display driving apparatus according to the embodiment of the present disclosure may comprise other numbers of display drivers and termination impedance matching networks, and the terminal impedance matching networks are provided in one-to-one correspondence with the display drivers.

Similarly, in the example of FIG. 3, the signal output by the display controller 301 may be four-parallel Mini-LVDS signals, and the four signal lines 304₁₊, 304₁₋, 304₂₊ and 304₂₋ carry video data output by a left half panel and a right half panel of a display panel respectively. According to the embodiment shown in FIG. 3, the display controller 301 and the display drivers 302₁-302₃ are arranged in a substantial “T-shaped” layout. For example, the intersection between the horizontal line and the vertical line of the “T-shape” may not be limited to a center of the horizontal line of the “T-shape”, and an angle between the horizontal line and the vertical line of the “T-shape” is not limited to 90 degrees. In FIG. 3, the terminal impedance matching networks 303₁-303₃ are provided in one-to-one correspondence with the display drivers 302₁-302₃, and the terminal impedance matching networks 303₁-303₃ are as close as possible to the corresponding display drivers 302₁-302₃. With this technical solution, a distributed capacitance of the parallel terminal impedance matching networks and the signal lines and an input capacitance of subsequent circuits can be used to weaken a steep degree of an edge of a signal and prevent overshoot in a case of reducing parallel applications. At the same time, in a case that an output frequency of the timing control IC is increased, even if a source driving IC with a weak output capability is used, a clock swing value of the source driving IC may not exceed the IC design specifications while improving electromagnetic interference.

According to the present embodiment, the terminal impedance matching networks 303₁-303₃ may have the same structure as that of the terminal impedance matching network 103 of FIG. 2, respectively. The termination impedance matching networks 303₁-303₃ may comprise impedance matching sub-networks 1031 and 1032 connected between two signal lines in each pair of signal lines respectively. The impedance matching sub-networks 1031 and 1032 may comprise a resistor R1 connected between the signal line 304₁₊ and the signal line 304₁₋ and a resistor R2 connected between the signal line 304₂₊ and the signal line 304₂₋ respectively. Here, an impedance value of each of the impedance matching sub-networks may be in a range of about 80 ohms to 100 ohms, for example, in a range of about 80 ohms to 85 ohms. For example, the impedance value of each of the impedance matching sub-networks may be about 82 ohms.

All the FIGS. 1 to 3 are described by taking an example in which the display controller outputs four data signals in four signal lines to the display drivers. It can be understood by those skilled in the art that a number of signal lines may be based on a resolution of the display panel. Of course, the data signals may be transmitted using, for example, 6 (3 pairs of) signal lines or 8 (4 pairs of) signal lines to support, for example, a ultra-high definition display panel with a resolution of 4K to display an image.

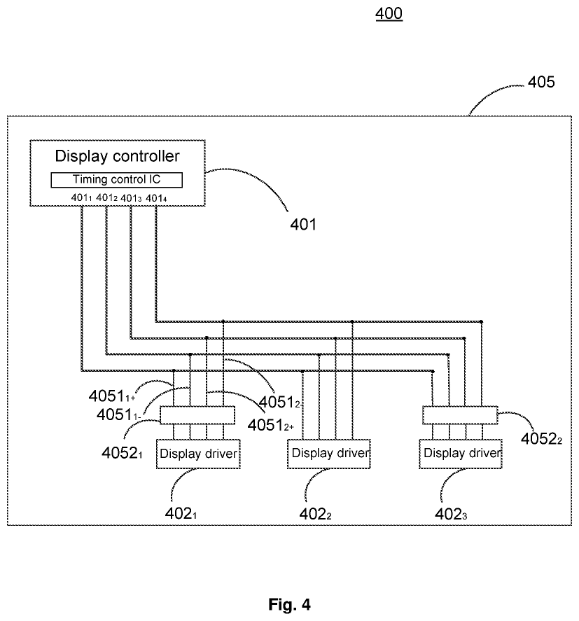

According to an embodiment of the present disclosure, there is further provided a display driving component. FIG. 4 illustrates a schematic block diagram of a display driving component according to an exemplary embodiment of the present disclosure. As shown in FIG. 4, the display driving component 400 according to the exemplary embodiment of the present disclosure may comprise a printed circuit board 405; a display controller 401 configured to generate a plurality of output signals, wherein the display controller 401 has a plurality of output ports 401₁-401₄ for outputting the generated plurality of output signals respectively; display drivers 402₁-402₃ configured to generate a display signal according to at least a part of the plurality of output signals output by the output ports 401₁-401₄; wherein the printed circuit board 405 further comprises terminal impedance matching networks 4052₁-4052₂ provided thereon, which are connected between the display controller 401 and the plurality of display drivers 402₁-402₃ via a plurality of signal lines 4051₁₊, 4051₁₋, 4051₂₊ and 4051₂₋ on the printed circuit board.

For example, in the example of FIG. 4, the display controller 401 and the display drivers 402₁-402₃ are arranged in an “L-shaped” layout. In FIG. 4, there is no termination impedance matching network provided for the display driver 402₂. With this technical solution, the space can be saved and the design of the terminal impedance matching networks can be simplified.

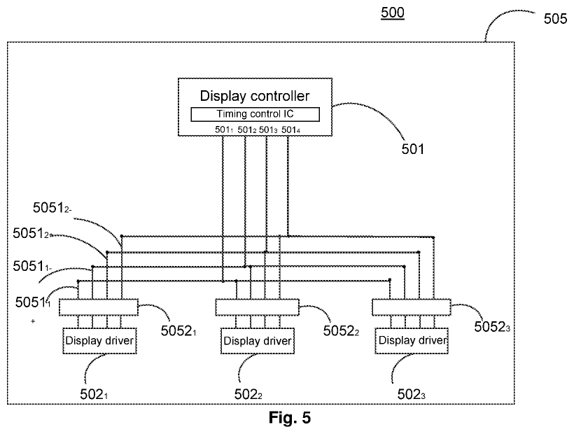

FIG. 5 illustrates a schematic block diagram of a display driving component according to another exemplary embodiment of the present disclosure. As shown in FIG. 5, the display driving component 500 according to the other exemplary embodiment of the present disclosure may comprise: a printed circuit board 505; a display controller 501 configured to generate a plurality of output signals, wherein the display controller 501 has a plurality of output ports 501₁-501₄ for outputting the generated plurality of output signals; display drivers 502₁-502₃ configured to generate a display signal according to at least a part of the plurality of output signals output by the output ports 501₁-501₄; wherein the printed circuit board 505 further comprise terminal impedance matching networks 5052₁-5052₃ provided thereon, which are connected between the display controller 501 and the display drivers 502₁-502₃ via a plurality of signal lines 5051₁₊, 5051₁₋, 5051₂₊ and 5051₂₋ on the printed circuit board.

Unlike the embodiment shown in FIG. 4, the embodiment shown in FIG. 5 provides a terminal impedance arrangement with a substantial “T-shaped” layout, and a termination impedance matching network is added at an intersection between a horizontal line and a vertical line of a “T-shape” in the substantial “T-shaped” network. The display controller 501 may be provided on a central line of the printed circuit board 505. For example, the display controller 501 may be provided at a center of the printed circuit board 505, and the display controller 501 and the display drivers 502₁-502₃ are arranged in the substantial “T-shaped” layout, which can more effectively eliminate signal reflection of an output high-frequency signal on a communication line. For example, the intersection between the horizontal line and the vertical line of the “T-shape” may not be limited to a center of the horizontal line of the “T-shape”, and an angle between the horizontal line and the vertical line of the “T-shape” is not limited to 90 degrees. The terminal impedance matching networks may be as close as possible to corresponding signal receivers, i.e., the display drivers, thereby more effectively realizing impedance matching between the signal source and the transmission lines, reducing reflection and avoiding oscillation.

Similarly to that described with reference to FIG. 2, for each of the display drivers 502₁-502₃, the display controller 501 is connected to the display driver via at least one pair of signal lines in the plurality of signal lines, and the termination impedance matching networks each comprise impedance matching sub-networks between two signal lines in each pair of signal lines. The impedance matching sub-networks have the same impedance value. In consideration of a manufacturing capability of the printed circuit board, an impedance value of the impedance matching sub-networks may be in a range of about 80 ohms to 100 ohms, for example, in a range of about 80 ohms to 85 ohms, or for example, the impedance value of the impedance matching sub-networks may be about 82 ohms.

The embodiments of the present disclosure further provide a display device comprising the display driving apparatus according to the embodiment of the present disclosure as described above.

The embodiments of the present disclosure further provide a display device comprising the display driving component according to the embodiment of the present disclosure as described above.

The display device according to the embodiment of the present disclosure may be any product or component having a display function such as an electronic paper, a mobile phone, a tablet computer, a television, a display, a notebook computer, a digital photo frame, a navigator, etc.

According to an embodiment of the present disclosure, reflection of a signal arriving at the end of a transmission line can be alleviated by adding terminal impedance matching networks. By adding the termination impedance matching networks and properly setting a number and positions of the terminal impedance matching networks, impedance matching between a signal source and the transmission line can be realized to reduce reflection and avoid oscillation, while reducing noises and radiation and preventing overshoot.

While the present disclosure has been particularly shown and described with reference to the exemplary embodiments of the present disclosure, it will be understood by those of ordinary skill in the art that these embodiments can be changed variously in form and detail without departing from the spirit and scope of the present disclosure defined by the attached claims.

1. A display driving apparatus, comprising:
a display controller configured to generate a plurality of output signals, wherein the display controller has a plurality of output ports for outputting the generated plurality of output signals respectively;
display drivers configured to generate a display signal according to at least a part of the plurality of output signals output by the output ports; and
termination impedance matching networks connected between the display controller and the display drivers via a plurality of signal lines.

2. The display driving apparatus according to claim 1, wherein for each of the display drivers, the display controller is connected to the display driver via at least one pair of signal lines of the plurality of signal lines, and the termination impedance matching networks each comprise impedance matching sub-networks connected between two signal lines of each pair of signal lines.

3. The display driving apparatus according to claim 2, wherein the impedance matching sub-networks have the same impedance value.

4. The display driving apparatus according to claim 3, wherein the impedance matching sub-networks each have an impedance value in a range of about 80 ohms to 85 ohms.

5. The display driving apparatus according to claim 3, wherein the impedance matching sub-networks each comprise at least one resistor.

6. The display driving apparatus according to claim 1, wherein the display controller and the display drivers are arranged in a substantial T-shaped layout.

7. The display driving apparatus according to claim 1, wherein the termination impedance matching networks are as close as possible to the corresponding display drivers.

8. The display driving apparatus according to claim 1, wherein the display controller comprises a timing control Integrated Circuit (IC) configured to receive an external signal and convert the received external signal into the plurality of output signals.

9. The display driving apparatus according to claim 8, wherein the plurality of output signals are high-frequency signals transmitted in a form of Low Voltage Differential Signal (LVDS).

10. A display driving component, comprising:
a printed circuit board;
a display controller configured to generate a plurality of signals, wherein the display controller has a plurality of output ports for outputting the generated plurality of signals respectively; and
display drivers configured to generate a display signal according to at least a part of the plurality of signals output by the output ports;
wherein the printed circuit board has termination impedance matching networks provided thereon, which are connected between the display controller and the display drivers via a plurality of signal lines on the printed circuit board.

11. The display driving component according to claim 10, wherein the display controller is located on a central line of the printed circuit board.

12. The display driving component according to claim 11, wherein the display controller is located at a center of the printed circuit board.

13. The display driving component according to claim 10, wherein the display controller and the display drivers are arranged in a substantial T-shaped layout.

14. The display driving component according to claim 10, wherein the termination impedance matching networks are as close as possible to the corresponding display drivers.

15. The display driving component according to claim 10, wherein the display controller comprises a timing control Integrated Circuit (IC) configured to receive an external signal and convert the received external signal into the plurality of output signals.

16. The display driving component according to claim 15, wherein the plurality of output signals are high-frequency signals transmitted in a form of Low Voltage Differential Signal (LVDS).

17. The display driving component according to claim 10, wherein for each of the display drivers, the display controller is connected to the display driver via at least one pair of signal lines of the plurality of signal lines, and the termination impedance matching networks each comprise impedance matching sub-networks connected between two signal lines of each pair of signal lines.

18. The display driving component according to claim 17, wherein the impedance matching sub-networks have the same impedance value.

19. (canceled)

20. (canceled)

21. A display device comprising the display driving apparatus according to claim 1.

22. A display device comprising the display driving component according to claim 10.
